(19) United States
(12) Patent Application Publication
(10) Pub. No.: US 2006/0032810 A1
(43) Pub. Date: Feb. 16, 2006

(54) Tuna spinner

(76) Inventor: Theresa M. Dudley, Montague, TX (US)

Correspondence Address: Theresa M. Dudley, RR #1 Box 43, Montague, TX, 76251, US

(21) Appl. No.: 10/843,259

(22) Filed: Aug. 16, 2004

(51) Int. Cl. B01D 29/00

(52) U.S. Cl. 210/464; 210/473; 99/495; 99/506; 99/508; 210/497.01; 210/499

(57) ABSTRACT

Tuna Spinner—in the application of small electrical kitchen appliances—is a small wire mesh or perforated plastic basket that fits within the outer bowl unit of current and/or future food processors, (or an appliance of it's own with motorized base and outer bowl unit) and replacing the blade unit, that allows the ‘spinning’ of oil or water from typical canned tuna or salmon, or other food product packaged in liquid suspension. Tuna Spinner takes the ‘hassle’ out of messy draining of these food products, as well as eliminating damage to the food product.

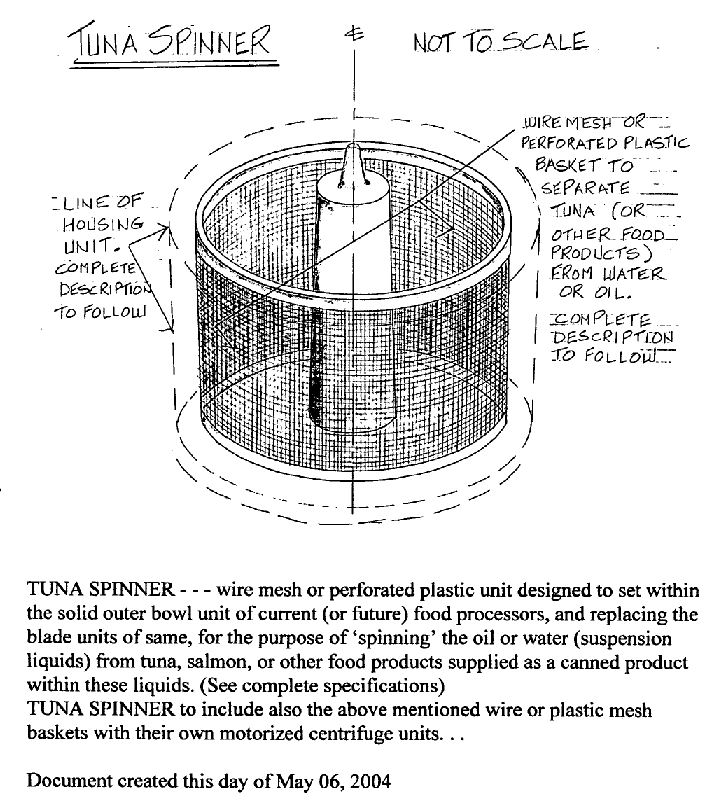

Tuna Spinner is a small kitchen appliance for the purpose of separating oil or water from canned tuna, salmon, or other food product. Tuna Spinner would be manufactured as a small wire or plastic mesh basket that fits within the bowls of current food processing units, replacing the blade portion, or the wire or plastic mesh basket with it's own motorized unit and plastic bowl housing. Tuna Spinner would be used in the manner of placing tuna or salmon (or other food product packaged in liquid) within the wire mesh basket, spinning to remove the liquid, which would be caught in the outer solid plastic bowl for disposal.

### CROSS-REFERENCE TO RELATED APPLICATIONS

Tuna Spinner can be applicable to current small kitchen appliances, the food processor; an addition to the function of same, or a small appliance of it's own.

### STATEMENT REGARDING FEDERALLY SPONSORED RESEARCH OR DEVELOPMENT

not applicable

### REFERENCE TO SEQUENCE LISTING, A TABLE, OR A COMPUTER PROGRAM LISTING COMPACT DISK APPENDIX

not applicable

### BACKGROUND OF THE INVENTION

Tuna Spinner pertains to the endeavor of cooking, within the kitchen. Tuna Spinner being a small motorized kitchen appliance that takes the work out of separating the oil or water from tuna, salmon or other food products that are required to be drained before use. The idea was formed during the many times that I have hand squeezed the liquid from these foods through a strainer, and from the fact that no appliance on the market today seems to have addressed this little problem faced by anyone attempting to drain liquid from these food products.

### BRIEF SUMMARY OF THE INVENTION

Tuna Spinner is a small wire mesh or plastic mesh basket that fits upon (and replacing the blade) the blade socket of current and\or future centrifuge small kitchen appliances (food processors), and within the outer solid plastic bowl unit; allowing the spinning process of wire basket to remove oil or water from the food product, while retaining the liquid to be discarded within the outer bowl; OR the wire or plastic mesh basket with it's own motorized base and solid plastic outer bowl unit. Tuna Spinner would eliminate the drudgery and mess of ‘draining’ liquid from food products packaged as such, as well as achieving a much more efficient job of squeezing the liquid from the food product without damaging the food itself.

### BRIEF DESCRIPTION OF THE SEVERAL VIEWS OF THE DRAWING

One (1) drawing (initially) supplied with application for patent on Tuna Spinner, visualizing the internal basket unit that would set within the outer housing unit of current kitchen food processors, and upon the blade socket (replacing the blade), and within the solid outer bowl. Dashed lines of the drawing show typical food processor outer bowl unit with the ‘tuna spinner’ mesh basket within. The motorized base unit of food processors is not shown, as this is not the area of invention, though tuna spinner could also be the mesh basket with it's own motorized unit and solid outer bowl.

### DETAILED DESCRIPTION OF THE INVENTION

Tuna Spinner—a wire mesh or plastic mesh basket unit—mesh being that of ‘strainer’ size for wire mesh, or small perforated holes within the plastic version, mesh allowing the escape of liquid while containing food products. Basket would be sized to fit within the larger outer plastic solid bowls of current and/or future food processors (or within it's own outer bowl in the case of tuna spinner being entire unit of it's own), allowing approximately three quarters of an inch clearance surrounding mesh basket to outer bowl, and on the underside of mesh basket to bottom of solid outer bowl, of sufficient size and clearance to capture liquid as it is spun out of the food contained within the inner mesh basket. Basket would have an inner center solid portion that slides over the center portion of the solid outer bowl, and within this solid center portion would be the ‘gear’ mechanism that fits the slot where the blade unit (of typical food processors) is normally placed. Drawing supplied with this application details the mesh basket shown within ‘dashed lines’ that depict the solid outer bowl mentioned here, and drawing shows center portion that would fit the slot for the blade unit of typical food processors. Exact sizing of mesh basket and construction of ‘inner slot area’ would be in accordance with variations of construction and sizing of current and/or future food processors for which the tuna spinner would be manufactured; or the tuna spinner with it's own outer housing bowl and motorized base unit would be of similar size as current food processors. Mesh basket would be same materials, either in the wire mesh version or the plastic perforated basket version, as typical kitchen utensils and small appliances, durable for multiple uses and dishwasher safe. All codes and safety features that are applicable to typical appliances would be applied in accordance.

Tuna Spinner as described here-in is not to be confused with any other ‘spinner’ devise currently on the market, as the tuna spinner is a totally independent and unique invention of it's own, being of different capacity and sizing and designed to be implemented upon a motorized centrifuge base unit.

1. What I claim as my invention is the Tuna Spinner; in the area of small electrical kitchen appliances, an addition to the current and/or future food processing units, or a small appliance of it's own. Tuna Spinner is the name applied to a small wire mesh or perforated plastic basket that would fit within the solid outer bowl of current food processing units, and upon the area where the blade unit normally fits; and/or this mesh basket with it's own outer bowl and motorized unit. In either case, it is the wire mesh or perforated plastic inner basket applied in the manner described above that is the subject of my invention and for which a patent is sought, a product which to my knowledge does not exist. Tuna Spinner would perform what the name implies, ‘spinning tuna’—within the mesh basket upon the motorized base, the liquid to be discarded contained within the solid outer bowl. Tuna Spinner's uses would extend to other food products that are packaged in liquid suspension that require draining before use, allowing ease of more efficient draining of the liquids without damage to the food product. Tuna Spinner is not to be confused with any other ‘spinner’ devise currently on the market, as the tuna spinner is a totally independent and unique invention of it's own, being of different capacity and sizing and designed to be implemented upon a motorized centrifuge base unit.
